(19) United States
(12) Patent Application Publication
(10) Pub. No.: US 2007/0288948 A1
(43) Pub. Date: Dec. 13, 2007

(54) Information Recording Medium, and Information Reproducing Apparatus and Method

(76) Inventors: Kazuo Kuroda, Saitama (JP); Masahiro Kato, Saitama (JP)

Correspondence Address: YOUNG & THOMPSON, 745 SOUTH 23RD STREET, 2ND FLOOR, ARLINGTON, VA, 22202, US

(21) Appl. No.: 11/596,073

(22) PCT Filed: May 9, 2005
(86) PCT No.: PCT/JP05/08409

§ 371 Date: Feb. 9, 2007

(30) Foreign Application Priority Data
May 10, 2004 (JP) 2004-140357

(51) Int. Cl. G11B 7/007

(52) U.S. Cl. 720/718

(57) ABSTRACT

An information recording medium in which a groove track oscillated at a first frequency and capable of recording record information is provided with a plurality of recording layers formed previously, and the groove track has a first region (111) capable of detecting synchronization information and address information (LP), and a second region (112) capable of detecting information for discriminating the recording layers.

### TECHNICAL FIELD

The present invention relates to an information recording medium, such as a DVD, for example, and an information reproducing apparatus for and an information reproducing method of reproducing record data recorded on the information recording medium.

### BACKGROUND ART

In an information recording medium, such as a CD and a DVD, for example, there is also developed an optical disc of a dual layer type or multiple layer (multilayer) type, in which a plurality of recording layers are laminated or stacked on the same substrate. Then, on an information recording apparatus, such as a CD recorder, which performs recording with respect to the dual layer type, i.e., two-layer type optical disc, information is recorded in an irreversible change recording method by heat or the like, or in a rewritable method, into a recording layer located on the front (i.e. on the closest side) viewed from a laser light irradiation side (hereinafter referred to as an “L0 layer”, as occasion demands), by focusing the laser light for recording on the L0 layer. On the other hand, information is recorded in the irreversible change recording method by heat or the like, or in the rewritable method, into a recording layer located on the rear of the L0 layer viewed from the laser light irradiation side (hereinafter referred to as an “L1 layer”, as occasion demands), by focusing the laser light for recording on the L1 layer through the L0 layer.

In reproducing the record data recorded on such a multilayer type optical disc, a technology of judging or determining each recording layer in a short time is desired. For example, a patent document 1 discloses a technology of judging each recording layer by arranging a land pre-pit for the different phase of the wobble, depending on each recording layer, and by detecting a phase difference between a signal from the wobble and a signal from the land pre-pit

Moreover, a patent document 2 discloses a technology of judging each recording layer by arranging the land pre-pit on the inner or outer circumferential side of the optical disc, on the basis of a groove track on which the wobble is formed, depending on each recording layer, and by detecting whether the signal from the land-pre-pit is generated in a peak position of the signal from the wobble located on the inner or the outer circumferential side of the optical disc.
Patent document 1: Japanese Patent Application Laid Open NO. 2002-319144
Patent document 2: Japanese Patent Application Laid Open NO. 2002-329328
Patent document 3: Japanese Patent Application Laid Open NO. Hei 9-326138

However, in the patent document 1, there is such a technical problem that it is difficult to detect the phase difference because the signal from the land pre-pit includes a signal from the land pre-pit with respect to the groove track adjacently arranged. Moreover, in the patent document 2, there is such a technical problem that it is necessary to provide a land pre-pit detection circuit on the inner and outer circumferential sides and to change an input signal which is inputted to a land pre-pit decoder in accordance with the detection result of each recording layer.

In addition, in the patent documents 1 and 2, in any case, it is necessary to decode the signal from the land pre-pit, so that there is such a technical problem that it causes an increase in processing load of a signal processing circuit and an increase in cost of a signal processing circuit to be added if it is desired to realize a fast signal process.

In order to solve the above-mentioned conventional problem, it is therefore an object of the present invention to provide an information recording medium, an information reproducing apparatus, and an information reproducing method, which enable fast and simple judgment of each recording layer on the multilayer type information recording medium, for example.

Means for Solving the Object

(Information Recording Medium)

Hereinafter, the information recording medium of the present invention will be explained.

The above object of the present invention can be achieved by an information recording medium, provided with: a plurality of recording layers, on each of which a groove track, which is oscillated or wobbled at a first frequency and in which record information can be recorded, is formed in advance, the groove track provided with: a first area (e.g. three wobbles on the front side) in which synchronization information and address information can be detected; and a second area (e.g. five wobbles on the rear side) in which layer judgment information for judging the recording layers can be detected.

According to the information recording medium of the present invention, in the first area of the sync frame of the groove track, for example, (i) the synchronization information including a synchronization signal and (ii) the address information are recorded by using the land pre-pit. Moreover, in the second area continued from the first area, the layer judgment information is recorded. The “layer judgment information” herein is identification information which is capable of judging each recording layer and which is peculiar to each recording layer. One specific example of the layer judgment information may be formed the shape of the groove track peculiar to each recording layer. More specifically, in the second area, it is replaced by another wobble which is oscillated or wobbled at a frequency different from the first frequency, which is a reference frequency, in a particular position. Thus, by changing the position where a position is replaced by another wobble, it is possible to change the shape of the groove track in each recording layer. Therefore, it is possible to detect the layer judgment information, i.e. the shape of the groove track peculiar to each recording layer, by using an information reproducing apparatus described later. Here, the “detection” in the present invention is not to decode encoded information by using a decoder, but to identify information on the basis of a push-pull signal from the wobble. More specifically, by that the information reproducing apparatus detects the above-mentioned position where it is replaced by another wobble on the basis of the push-pull signal, the shape of the groove track peculiar to each recording layer is judged, and each recording layer can be judged or identified, quickly and easily.

If the layer judgment information is recorded in the land pre-pit, for example, it is necessary to decode the signal from the land pre-pit, so that it causes an increase in processing load of a signal processing circuit and an increase in cost of a signal processing circuit to be added if it is desired to realize a fast signal process.

In contrast, according to the present invention, it is possible to change the shape of the groove track in each recording layer by changing the position where it is replaced by another wobble. Namely, by associating the shape of the groove track in the second area with the layer judgment information in a one-to-one way, by definition, the position where it is replaced by another wobble is detected by the information reproducing apparatus described later, without the layer judgment information decoded. By this the shape of the groove track peculiar to each recording layer is judged, and each recording layer can be judged or identified, quickly and easily.

In one aspect of the information recording medium of the present invention, the groove track includes a first wobble which is oscillated or wobbled at a second frequency different from the first frequency, in the second area.

According to this aspect, in the second area of the groove track, it is replaced by the first wobble which is oscillated or wobbled at the second frequency different from the first frequency, which is the reference frequency, in a particular position. Thus, the position where it is replaced by the first wobble is more easily detected and thereby identified, by the information reproducing apparatus described later, without the layer judgment information decoded. By this, the shape of the groove track peculiar to each recording layer is judged, more easily, and each recording layer can be judged or identified, more quickly and easily.

In another aspect of the information recording medium of the present invention, the groove track includes a first land pre-pit which is formed at the same side in a radial direction of the information recording medium, as a land pre-pit formed in the first area.

According to this aspect, in the second area of the groove track, the first land pre-pit is formed at the top (or summit) of a particular wobble which is oscillated or wobbled at the first frequency as the reference frequency. Incidentally, the first land pre-pit is formed in the same direction (or same side) in the radial direction of the information recording medium as the land pre-pit formed in the first area. Thus, the first land pre-pit formed at the top of the particular wobble is easily detected and thereby identified, by the information reproducing apparatus described later, without the layer judgment information decoded. By this, the shape of the groove track peculiar to each recording layer is judged, more easily, and each recording layer can be judged or identified, more quickly and easily.

In another aspect of the information recording medium of the present invention, the groove track includes a second land pre-pit which is formed at opposite side in a radial direction of the information recording medium, to a land pre-pit formed in the first area.

According to this aspect, in the second area of the groove track, the second land pre-pit is formed, wherein the second land pre-pit is opposite side in the radial direction of the information recording medium, to the land pre-pit formed in the first area. More specifically, in the second area of the groove track, the second land pre-pit is formed at the lower top (or bottom) of a particular wobble which is oscillated or wobbled at the first frequency as the reference frequency. Thus, the second land pre-pit formed at the lower top (or bottom) of the particular wobble is easily detected and thereby identified, by the information reproducing apparatus described later, without the layer judgment information decoded. By this, the shape of the groove track peculiar to each recording layer is judged, more easily, and each recording layer can be judged or identified, more quickly and easily.

In another aspect of the information recording medium of the present invention, the groove track includes a second wobble to which a signal from or of another information is superimposed.

According to this aspect, in the second area of the groove track, the second wobble is formed. Here, the “second wobble” of the present invention is a wobble to which the signal from or of another information is superimposed. Thus, the second wobble is easily detected and thereby identified, by the information reproducing apparatus described later, without the layer judgment information decoded. By this, the shape of the groove track peculiar to each recording layer is judged, more easily, and each recording layer can be judged or identified, more quickly and easily.

In another aspect of the information recording medium of the present invention, the groove track includes a third wobble having a phase different from that of another wobble.

According to this aspect, in the second area of the groove track, the third wobble is formed. Here, the “third wobble” of the present invention is a wobble on which BP (Bi Phase) modulation is performed. The third wobble is easily detected and thereby identified, by the information reproducing apparatus described later, without the layer judgment information decoded. By this, the shape of the groove track peculiar to each recording layer is judged, more easily, and each recording layer can be judged or identified, more quickly and easily.

In another aspect of the information recording medium of the present invention, the groove track includes a fourth wobble having an amplitude different from that of another wobble.

According to this aspect, in the second area of the groove track, the fourth wobble is formed. Here, the “fourth wobble” of the present invention is a wobble on which AM (Amplitude Modulation) is performed. The fourth wobble is easily detected and thereby identified, by the information reproducing apparatus described later, without the layer judgment information decoded. By this, the shape of the groove track peculiar to each recording layer is judged, more easily, and each recording layer can be judged or identified, more quickly and easily.

In another aspect of the information recording medium of the present invention, the layer judgment information is recorded, not only in the second area but also in the first area, in addition to the synchronization information and the address information.

According to this aspect, the layer judgment information recorded in the first area and the layer judgment information recorded in the second areas are detected and verified (or checked). By this, it is possible to further improve the accuracy of the detected layer judgment information. Moreover, it is also possible to maintain compatibility with the detection circuit of a conventional information reproducing apparatus.

(Information Reproducing Apparatus)

The above object of the present invention can be also achieved by an information reproducing apparatus for reproducing the record information on the above-mentioned information recording medium of the present invention (including its various aspects), the information reproducing apparatus provided with: an optical pickup device for irradiating laser light onto the groove track and receiving its reflected light; an address detecting device for detecting the synchronization information and the address information recorded on the information recording medium, on the basis of an output of the optical pickup device; and a recording-layer detecting device for detecting the layer judgment information recorded on the information recording medium, on the basis of the output of the optical pickup device.

According to the information reproducing apparatus of the present invention, firstly, when the information recording medium is loaded, a seek operation is performed by the optical pickup device, to thereby obtain the data to be reproduced on a decoder. By this, various management data required for various processes on the information recording medium is obtained. On the basis of the management data, the information recording medium is accessed, in accordance with an instruction from a host apparatus or a backend or the like, for example.

Then, if a writing or reproducing command is inputted from the host apparatus or the like, the laser light emitted from the optical pickup device is focused-in the desired recording layer, and at the same time, it is irradiated onto the groove track of this recording layer.

Then, the address detecting device detects the push-pull signal indicating the signal from the wobble, for example, on the basis of an output signal corresponding to the amount of received light from a detector, mounted in the optical pickup device, for receiving a reflected light beam. At the same time, it detects the address information indicated by the land pre-pit, from the detected push-pull signal. In addition, the address detecting device generates and outputs the synchronization signal, on the basis of the cycle of the push-pull signal.

The recording-layer detecting device detects the layer judgment information from the second area provided for the groove track of each recording layer, on the basis of the synchronization signal. More specifically, the position where it is replaced by another wobble which is oscillated or wobbled at the frequency different from the first frequency, is detected and thereby identified, by the recording-layer detecting device, without the layer judgment information decoded. By this, the shape of the groove track peculiar to each recording layer is judged, more easily, and each recording layer can be judged or identified, more quickly and easily.

Incidentally, even the information reproducing apparatus of the present invention can adopt the same various aspects as those of the above-mentioned information recording medium, as occasion demands.

(Information Reproducing Method)

The above object of the present invention can be also achieved by an information reproducing method of reproducing the record information on the above-mentioned information recording medium of the present invention (including its various aspects), the information reproducing method provided with: a reading process of irradiating laser light onto the groove track and receiving its reflected light; an address detecting process of detecting the synchronization information and the address information recorded on the information recording medium, on the basis of an output of the reading process; and a recording-layer detecting process of detecting the layer judgment information recorded on the information recording medium, on the basis of the output of the reading process.

According to the information reproducing method of the present invention, as in the case of the information reproducing apparatus of the present invention, the position where it is replaced by another wobble which is oscillated or wobbled at the frequency different from the first frequency, for example, is detected and thereby identified, under the control of the recording-layer detecting process, without the layer judgment information decoded. By this, the shape of the groove track peculiar to each recording layer is judged, more easily, and each recording layer can be judged or identified, more quickly and easily. under the control of the recording-layer detecting process.

Incidentally, even the information reproducing method of the present invention can adopt the same various aspects as those of the above-mentioned information reproducing apparatus, as occasion demands.

These effects and other advantages of the present invention will become more apparent from the following embodiments.

As explained above, according to the information recording medium of the present invention, it is provided with: at least one recording layer; and the groove track provided with the first and second areas. Thus, the shape of the groove track peculiar to each recording layer is judged by the information reproducing apparatus described later, without the layer judgment information decoded, so that each recording layer can be judged or identified, quickly and easily. According to the information reproducing apparatus of the present invention, it is provided with: the optical pickup device; the address detecting device; and the recording-layer detecting device, and according to the information reproducing method of the present invention, it is provided with: the reading process; the address detecting process; and the recording-layer detecting process. Thus, the shape of the groove track peculiar to each recording layer is judged, without the layer judgment information decoded, so that each recording layer can be judged or identified, quickly and easily.

### BRIEF DESCRIPTION OF DRAWINGS

FIG. 1 are an outline plan view showing the basic structure of an optical disc in an embodiment of the information recording medium of the present invention, the optical disc having a plurality of recording areas, in the upper part, and a schematic conceptual view showing a recording area structure in the lower part in association with the upper part.

FIG. 2 is a partially enlarged perspective view showing a recording surface of the optical disc in the embodiment.

FIG. 3 are schematic conceptual views showing clock information and address information required at the time of recording and reproduction, obtained from the wobbling of a groove track, on the optical disc in the embodiment of the information recording medium of the present invention.

FIG. 4 is a conceptual view schematically showing a relationship among wobble formed in an L0 layer of the optical disc in the first embodiment of the information recording medium of the present invention, a 1 sync frame (synchronization frame) as the physical format of the optical disc, 1 sector, and 1 ECC (Error Correction Code) block.

FIG. 5 is a conceptual view schematically showing wobble formed in an L0 layer to an L3 layer of the optical disc in the first embodiment of the information recording medium of the present invention, and the sync frame as the physical format of the optical disc.

FIG. 6 is a table showing one specific example of layer judgment information of the optical disc in the first embodiment of the information recording medium of the present invention.

FIG. 7 is a block diagram showing the entire structure of an information recording/reproducing apparatus in an embodiment of the information reproducing apparatus of the present invention.

FIG. 8 is a block diagram showing the structure of a signal processing circuit in the embodiment of the information reproducing apparatus of the present invention.

FIG. 9 are timing charts showing an operation of judging the recording layer by using the signal processing circuit in the embodiment of the information reproducing apparatus of the present invention.

FIG. 10 is a conceptual view schematically showing the wobble formed in the L0 layer to the L3 layer of an optical disc in a second embodiment of the information recording medium of the present invention, and the sync frame as the physical format of the optical disc.

FIG. 11 is a conceptual view schematically showing the wobble formed in the L0 layer to the L3 layer of an optical disc in a third embodiment of the information recording medium of the present invention, and the sync frame as the physical format of the optical disc.

FIG. 12 is a conceptual view schematically showing the wobble formed in the L0 layer to the L3 layer of an optical disc in a fourth embodiment of the information recording medium of the present invention, and the sync frame as the physical format of the optical disc.

### DESCRIPTION OF REFERENCE CODES

1 . . . center hole, 10 . . . track, 11 . . . sector, 100 . . . optical disc, 101 . . . lead-in area, 102 . . . data area, 103 . . . lead-out area, 106 . . . transparent substrate, 107 . . . recording layer, 108 . . . reflective layer, 109 (109a) . . . wobble, 111 . . . front area, 112 . . . rear area, 113 . . . layer judgment information, 150 . . . OPC area, 200 . . . information recording/reproducing apparatus, 201 . . . objective lens, 202 . . . optical pickup, 203 . . . spindle motor, 204 . . . head amplifier, 210 . . . sum generation circuit, 211 . . . pit data demodulation circuit, 212 . . . pit data correction circuit, 213 . . . buffer, 214 . . . interface, 220 . . . push-pull signal generation circuit, 221 . . . low pass filter, 222 . . . servo unit, 227 . . . RAND table, 228 . . . spread spectrum demodulation circuit, 230 . . . spread spectrum data reproduction circuit, 300 . . . signal processing circuit, 301 . . . analog comparator, 301a . . . auto slicer, 302 . . . counter circuit, 303 . . . latch circuit, 304 . . . digital comparator, SS . . . spread spectrum data, CK . . . clock signal, CK1 . . . first clock signal, CK2 . . . second clock signal, GT . . . groove track, LT . . . land track, LB . . . laser light, LP . . . land pre-pit, RST . . . reset signal, Sync . . . synchronization signal

### BEST MODE FOR CARRYING OUT THE INVENTION

Hereinafter, the best mode for carrying out the present invention will be explained in each embodiment in order with reference to the drawings.

### First Embodiment of Information Recording Medium

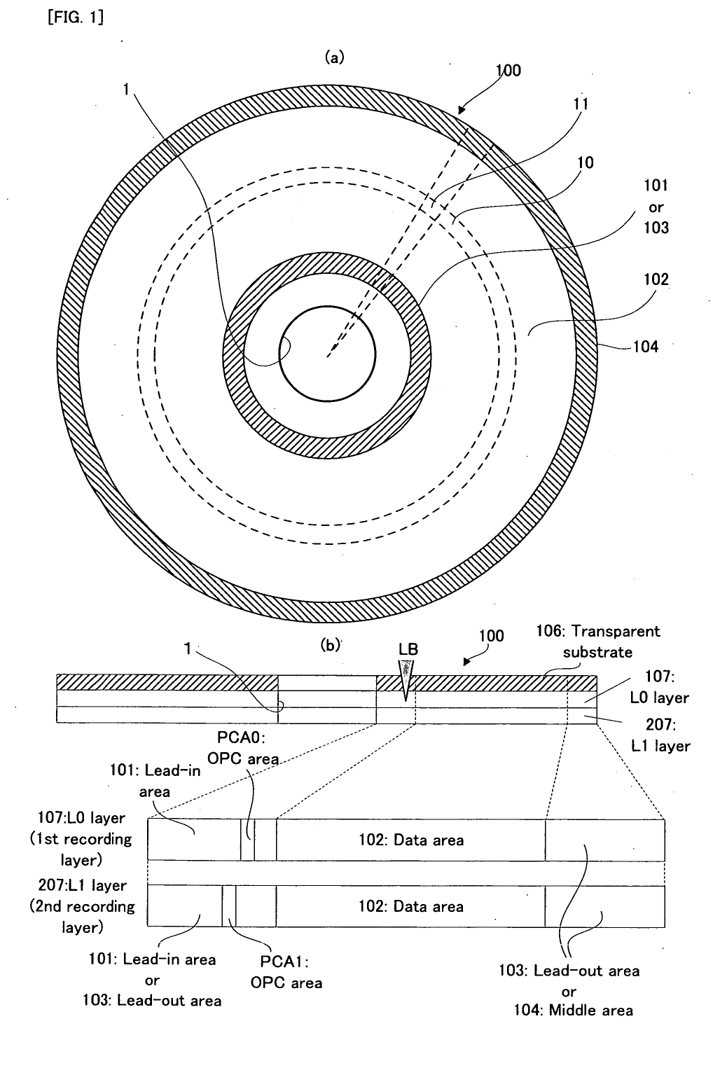

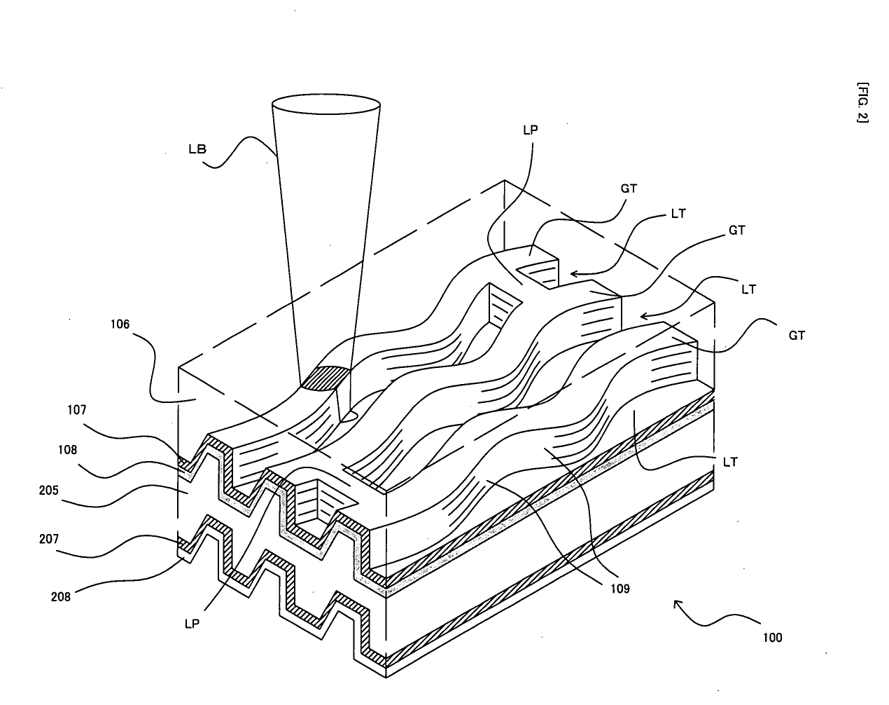

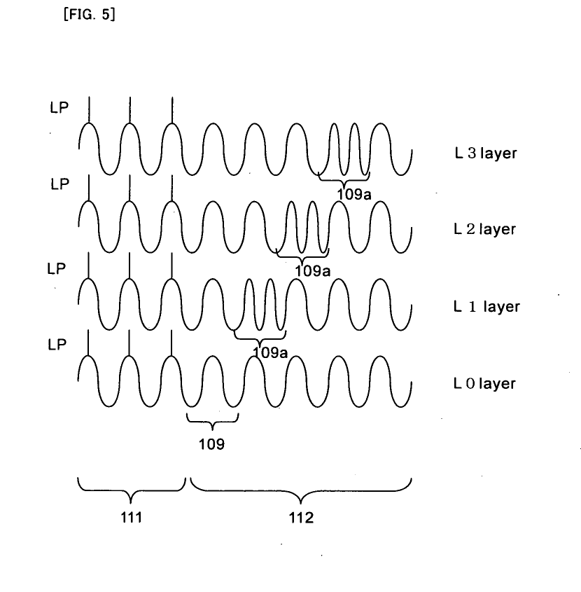

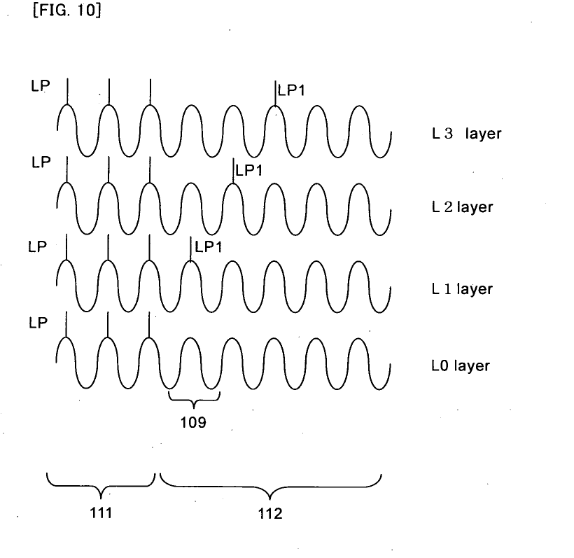

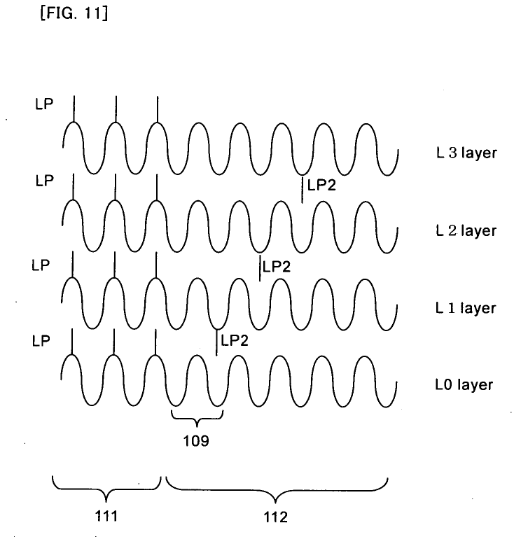

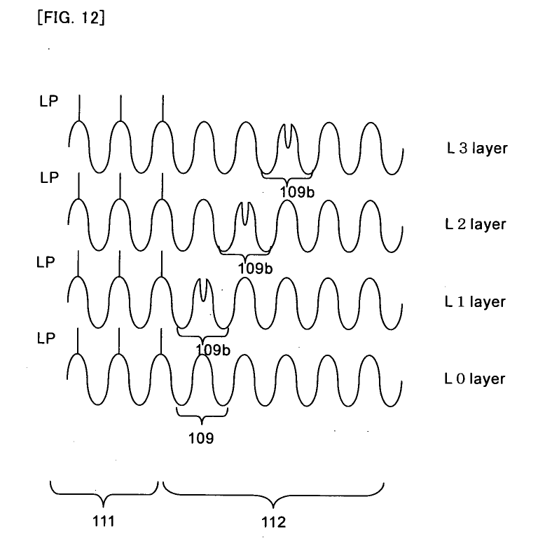

Next, with reference to FIG. 1 to FIG. 6, an optical disc in a first embodiment of the information recording medium of the present invention will be explained in detail, on the basis of the drawings. Incidentally, for convenience of explanation, in FIG. 1 and FIG. 2, laser light is irradiated from the upper side to the lower side, on the two-layer type optical disc in the embodiment of the information recording medium of the present invention. Thus, an L0 layer (first recording layer) is located on the upper side. On the other hand, in FIG. 5, FIG. 10, FIG. 11, and FIG. 12, the laser light is irradiated from the lower side to the upper side, on a multilayer type (four-layer type) optical disc in embodiments of the information recording medium of the present invention. Thus, the L0 layer (first recording layer) is located on the lower side.

Firstly, with reference to FIG. 1, an explanation will be given for the basic structure of the optical disc in the first embodiment of the information recording medium of the present invention. FIG. 1(a) is an outline plan view showing the basic structure of the optical disc in the first embodiment of the information recording medium of the present invention, the optical disc having a plurality of recording areas, in the upper part, and FIG. 1(b) is a schematic conceptual view showing a recording area structure in the lower part in association with the upper part.

As shown in FIG. 1(a) and FIG. 1(b), an optical disc 100 has a recording surface on a disc main body with a diameter of about 12 cm, as is a DVD. On the recording surface, the optical disc 100 is provided with: a center hole 1 as the center; a lead-in area 101; a data area 102; and a lead-out area 103 or a middle area 104, associated with the embodiment. In particular, for example, the lead-in area 101 is provided with an OPC area PCA0 or PCA1 where an OPC process is performed. Then, recording layers or the like are laminated on a transparent substrate 106. In each area of the recording layers, a track or tracks 10, such as a groove track and a land track, are alternately placed, spirally or concentrically, centered on the center hole 1, for example. Moreover, on the track 10, data is divided and recorded by a unit of ECC block 11. The ECC block 11 is a data management unit by pre-format address in which the record information can be error-corrected.

Incidentally, the present invention is not particularly limited to the optical disc having these three areas. For example, even if the lead-in area 101, the lead-out area 103, or the middle area 104 does not exist, a data structure explained later or the like can be constructed. Moreover, as described later, the lead-in area 101, the lead-out area 103, or the middle area 104 may be further segmentized.

In particular, the optical disc 100 in the embodiment has such a structure that that the L0 layer and the L1 layer, which constitute one example of the “first and second record layers” of the present invention descried later, respectively, are laminated on the transparent substrate 106. Upon the recording/reproduction of such a two-layer type optical disc 100, the recording/reproduction in the L0 layer or the L1 layer is performed, depending on which recording layer has the focus position of laser light LB, irradiated from the upper side to the lower side in FIG. 1(b). Moreover, the optical disc 100 in the embodiment is not limited to a two-layer single sided type, i.e., a dual layer type, but may be a two-layer double sided type, i.e., a dual layer double sided type. Furthermore, the optical disc 100 in the embodiment is not limited to the optical disc having the two recording layers, as described above, but may be an optical disc of a multilayer type which has three or more layers.

Incidentally, a recording/reproducing procedure on the two-layer type optical disc may be an opposite method in which the directions of track paths are opposite between the two recording layers, for example, or may be a parallel method in which the directions of track paths are the same between the two recording layers, for example.

Next, with reference to FIG. 2, an explanation will be given for the outline of the physical structure of the optical disc in the first embodiment of the information recording medium of the present invention. More specifically, the optical disc 100 in the first embodiment is constructed as the two-layer type optical disc on which a plurality of data zones 102 or the like are formed in a lamination structure, for example. FIG. 2 is a partially enlarged perspective view showing the recording surface of the optical disc in the first embodiment of the information recording medium of the present invention.

As shown in FIG. 2, in the first embodiment, the optical disc 100 has a first recording layer (L0 layer) 107 of a phase change type or of an irreversible change recording type by heat or the like, which constitutes an information recording surface, laminated on the lower side of the disc-shaped transparent substrate 106, and further has a semitransparent reflective film 108 on the lower side thereof. On the information recording surface constructed from the surface of the first recording layer 107, a groove track GT and a land track LT are alternately formed. Incidentally, upon recording and reproduction of the optical disc 100, for example, as shown in FIG. 2, the groove track GT is irradiated with laser light LB through the transparent substrate 106. For example, upon recording, the laser light LB is irradiated with a recording laser power, to thereby perform the writing by a phase change or the irreversible change recording by heat or the like, with respect to the first recording layer 107. On the other hand, upon reproduction, the laser light LB is irradiated with a reproduction laser power weaker than the recording laser power, by which the record data written in the first recording layer 107 is read.

In the first embodiment, the groove track GT is oscillated or wobbled with a constant amplitude and at a constant spatial frequency. In other words, the groove track GT is wobbled, and the cycle of the wobble 109 is set to a predetermined value. On the land track LT, there is formed an address pit which is referred to as a land pre-pit LP and which indicates pre-format address information. By virtue of the two addressing (i.e. the wobble 109 and the land pre-pit LP), it is possible to obtain information necessary for disc rotation control, generation of a recording clock, or data recording, such as a recording address, during the recording. Incidentally, it is also possible to record the pre-format address in advance, by modulating the wobble 109 of the groove track GT in a predetermined modulation method, such as frequency modulation and phase modulation.

Particularly in the first embodiment, a second recording layer (L1 layer) 207 is formed on the lower side of the semitransparent reflective film 108, and moreover, a reflective film 208 is formed on the lower side thereof The second recording layer 207 is constructed such that the recording and reproduction of the phase change type or of the irreversible change recording type by heat or the like can be performed in substantially the same manner as the first recording layer 107, by irradiating the laser light LB through the transparent substrate 106, the first recording layer 107, and the semitransparent reflective film 108. With regard to the second recording layer 207 and the reflective film 208, they may be laminated, i.e. film-formed, on the transparent substrate 106 on which the first recording layer 107 and the semitransparent reflective film 108 or the like are formed. Alternatively, after each of them is laminated, i.e. film-formed, on a different substrate, they may be pasted to the transparent substrate 106. Incidentally, between the semitransparent reflective film 108 and the second recording layer 207, there is provided a transparent middle layer 205 constructed from a transparent adhesive or the like, as occasion demands, according to the manufacturing method.

Upon the recording and reproduction of such a two-layer type optical disc 100, the recording and reproduction in the first recording layer 107 or the second recording layer 207 is performed, depending on which recording layer has the focus position of the laser light LB, that is, which recording layer is focused on.

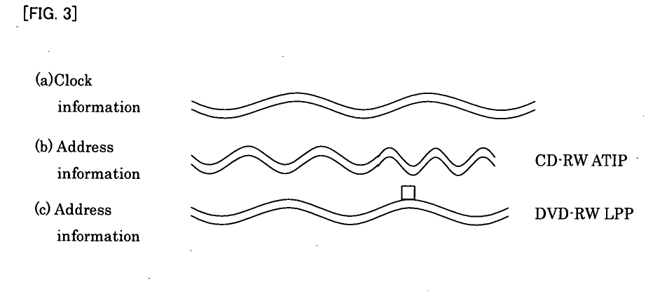

Next, with reference to FIG. 3, an explanation will be given for clock information and address information required at the time of recording and reproduction, obtained from the oscillation (wobbling) of the groove track, which is the basic principle of the optical disc in the embodiment of the information recording medium of the present invention. FIG. 3 are schematic conceptual views showing the clock information and the address information required at the time of recording and reproduction, obtained from the wobbling of the groove track, on the optical disc in the embodiment of the information recording medium of the present invention.

As shown in FIGS. 3(a), (b), and (c), the groove track GT is oscillated or wobbled with a constant amplitude and at a constant spatial frequency, on the optical disc in the embodiment. Namely, the groove track is wobbled, and the cycle of the wobble 109 is set to a predetermined value. Incidentally, it is also possible to record the pre-format address in advance, by modulating the wobble 109 of the groove track GT in a predetermined modulation method, such as frequency modulation and phase modulation.

As shown in FIG. 3(b), in the case of a CD-R/W, the address information on the optical disc is incorporated as absolute time information which is referred to as an ATIP (Absolute Time in Pre-groove) signal, due to a slight change in frequency.

As shown in FIG. 3(c), in the case of a DVD-R/RW, the address pit is formed on the land track LT, wherein the address pit is referred to as the land pre-pit LP indicating the pre-format address information, which is one specific example of the “address information” of the present invention.

By virtue of the above-explained two types of addressing, i.e. the wobble 109 and the ATIP, or the land pre-pit LP, it is possible to obtain information necessary for disc rotation control, generation of a recording clock, or data recording, such as a recording address, during the recording.

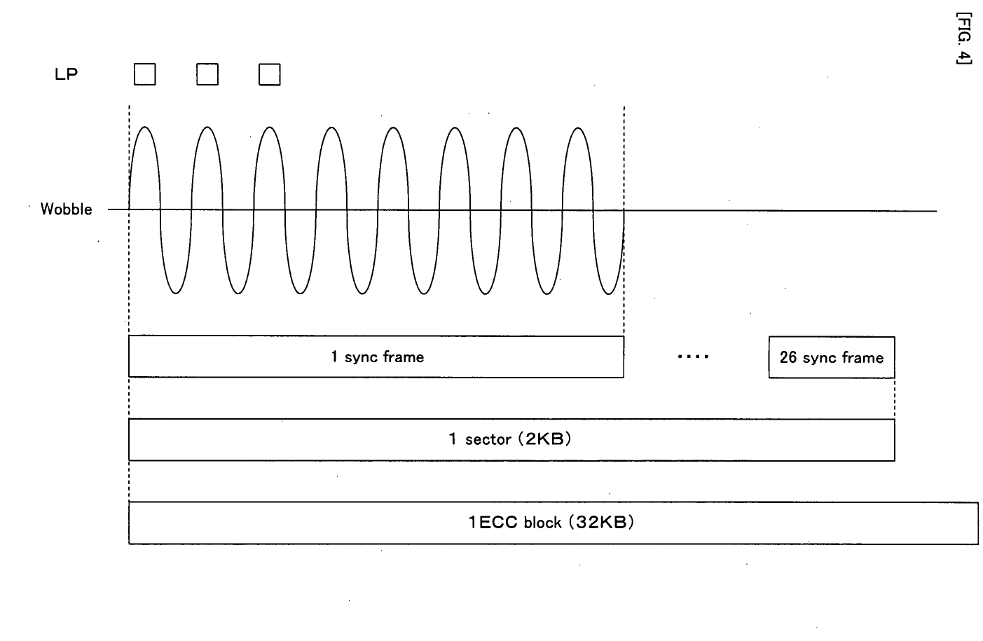

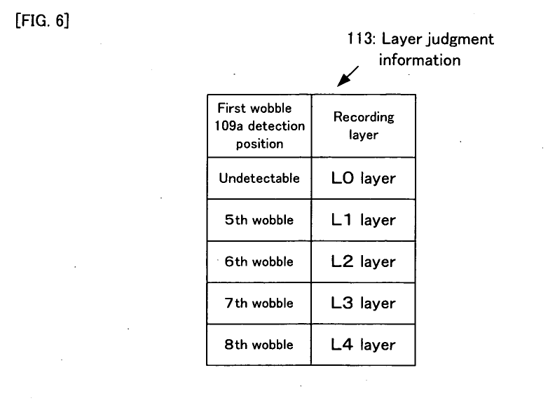

Next, with reference to FIG. 4 to FIG. 6, the optical disc in the first embodiment of the information recording medium of the present invention will be explained in more detail. FIG. 4 is a conceptual view schematically showing a relationship among (i) the wobble formed in the L0 layer of the optical disc in the first embodiment of the information recording medium of the present invention, (i) a 1 sync frame (synchronization frame) as the physical format of the optical disc, (iii) 1 sector, and (iv) 1 ECC (Error Correction Code) block. FIG. 5 is a conceptual view schematically showing (i) wobble formed in the L0 layer to an L3 layer of the optical disc in the first embodiment of the information recording medium of the present invention, and (ii) the sync frame as the physical format of the optical disc. FIG. 6 is a table showing one specific example of layer judgment information of the optical disc in the first embodiment of the information recording medium of the present invention.

As shown in FIG. 4, in the L0 layer of the optical disc in the first embodiment of the information recording medium of the present invention, eight wobbles 109 are formed in 1 sync frame. By collecting 26 sync frames (i.e., 26 pieces of sync frames), a sector is constructed having a data size of 2 (KB: Kilo Bytes), and by collecting 16 sectors (i.e., 16 pieces of sectors), 1 ECC block is constructed having a data size of 32 KB.

The plurality of land pre-pits LP is formed at three tops of the wobble 109 counted from the first positioned wobble 109, in each one sync frame, i.e. in each eight wobbles. The land pre-pit LP is constructed to include the address information and the clock information (or a timing signal) for synchronizing for the recording and reproduction of the data, as described above. More specifically, in at least one of the three land pre-pits LP, the clock information for the synchronization is recorded. In the other land pre-pits LP, the address information or information for controlling the data recording, or the like, are recorded.

As shown in FIG. 5, in the L0 layer of the optical disc in the first embodiment, eight wobbles are formed in one sync frame, as described above. Namely, the wobble 109 is formed at such a reference frequency that it oscillates eight times in one sync frame. The “reference frequency” herein is a concept indicating a frequency which is the reference of the oscillating wobble 109. Incidentally, the L0 layer may have the same shape as that of the groove track GT of a conventional DVD. Namely, in the L0 layer, the groove track GT oscillates at the same frequency as the reference frequency.

Moreover, one sync frame is provided with: a front area 111 located on the front side where three wobbles are formed; and a rear area 112 located on the rear side where five wobbles are formed. At the tops (or summits) of the three wobbles in the front area 111, there are formed the three land pre-pits LP, as described above. Incidentally, one example of the “first area” of the present invention is constructed from the front area 111. Moreover, one example of the “second area” of the present invention is constructed from the rear area 112.

In particular, in the L1 layer of the optical disc in the first embodiment, the frequency of oscillating (i-a) the fifth wobble from the head out of the eight wobbles in one sync frame as described above, in other words, (i-b) the second wobble 109a in the rear area 112, is frequency-modulated. More specifically, it is formed such that the frequency of oscillating the wobble 109a is twice as much as the reference frequency, for example. Incidentally, one example of the “first wobble” of the present invention is constructed from the wobble 109a which has the frequency that is twice as much as the reference frequency. From the opposite viewpoint, by that the detection circuit of an information reproducing apparatus described later detects the wobble 109a as the fifth wobble, it is possible to judge that the recording layer in which tracking (i.e., tracking control or tracking servo) is being performed is the L1 layer (refer to a table showing layer judgment information 113 in FIG. 6).

In the same manner, in the L2 layer of the optical disc in the first embodiment, the sixth wobble out of the eight wobbles in one sync frame is formed as the wobble 109a. From the opposite viewpoint, by that the detection circuit of the information reproducing apparatus detects the wobble 109a as the sixth wobble, it is possible to judge that the recording layer in which the tracking is being performed is the L2 layer (refer to the table showing the layer judgment information 113 in FIG. 6). Moreover, in the L3 layer of the optical disc in the first embodiment, the seventh wobble out of the eight wobbles in one sync frame is formed as the wobble 109a. From the opposite viewpoint, by that the detection circuit of the information reproducing apparatus detects the wobble 109a as the seventh wobble, it is possible to judge that the recording layer in which the tracking is being performed is the L3 layer (refer to the table showing the layer judgment information 113 in FIG. 6). Moreover, this is not shown in FIG. 5, but in an L4 layer of the optical disc in the first embodiment, the eighth wobble out of the eight wobbles in one sync frame is formed as the wobble 109a. From the opposite viewpoint, by that the detection circuit of the information reproducing apparatus detects the wobble 109a as the eighth wobble, it is possible to judge that the recording layer in which the tracking is being performed is the L4 layer (refer to the table showing the layer judgment information 113 in FIG. 6).

Consequently, according to the optical disc in the first embodiment of the information recording medium of the present invention, it is possible to judge each recording layer by detecting a particular position where it is replaced by the wobble 109a which is oscillated or wobbled at the frequency-modulated frequency, such as the frequency oscillated or wobbled twice as much as the reference frequency. More specifically, in the front area 111 of the sync frame of the groove track, the address information and synchronization information including a synchronization signal are recorded by the land pre-pits LP. Moreover, in the rear area 112, it is replaced by the wobble 109a which is oscillated or wobbled at the frequency-modulated frequency, in the particular position. Thus, by changing the position where it is replaced by the wobble 109a, it is possible to change the shape of the groove track in each recording layer. Therefore, by that the information reproducing apparatus described later detects the position where it is replaced by the wobble 109a, the shape of the groove track peculiar to each recording layer is judged, and each recording layer can be judged or identified, quickly and easily.

If the layer judgment information is recorded in the land pre-pit LP, for example, it is necessary to decode a signal from the land pre-pit LP, so that it causes an increase in processing load of a signal processing circuit and an increase in cost of a signal processing circuit to be added if it is desired to realize a fast signal process.

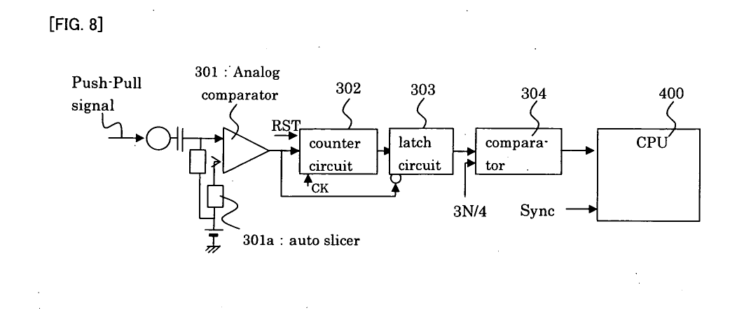

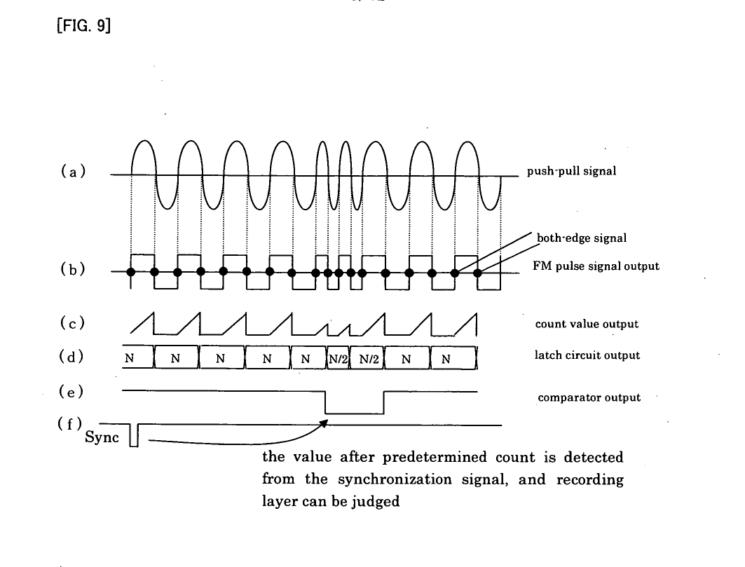

In contrast, according to the optical disc in the first embodiment, it is possible to change the shape of the groove track GT in each recording layer by changing the position where it is replaced by the wobble 109a. Namely, by associating the shape of the groove track GT in the rear area 112 with the layer judgment information 113 in a one-to-one way, by definition, the position where it is replaced by the wobble 109a is detected by the information reproducing apparatus described later, without the layer judgment information decoded. By this, the shape of the groove track peculiar to each recording layer is judged, and each recording layer can be judged or identified, quickly and easily. Incidentally, the detection circuit of the layer judgment information 113 and the detection principle will be explained in detail, in FIG. 8 and FIG. 9 described later.

(Explanation of Entire Information Recording/Reproducing Apparatus)

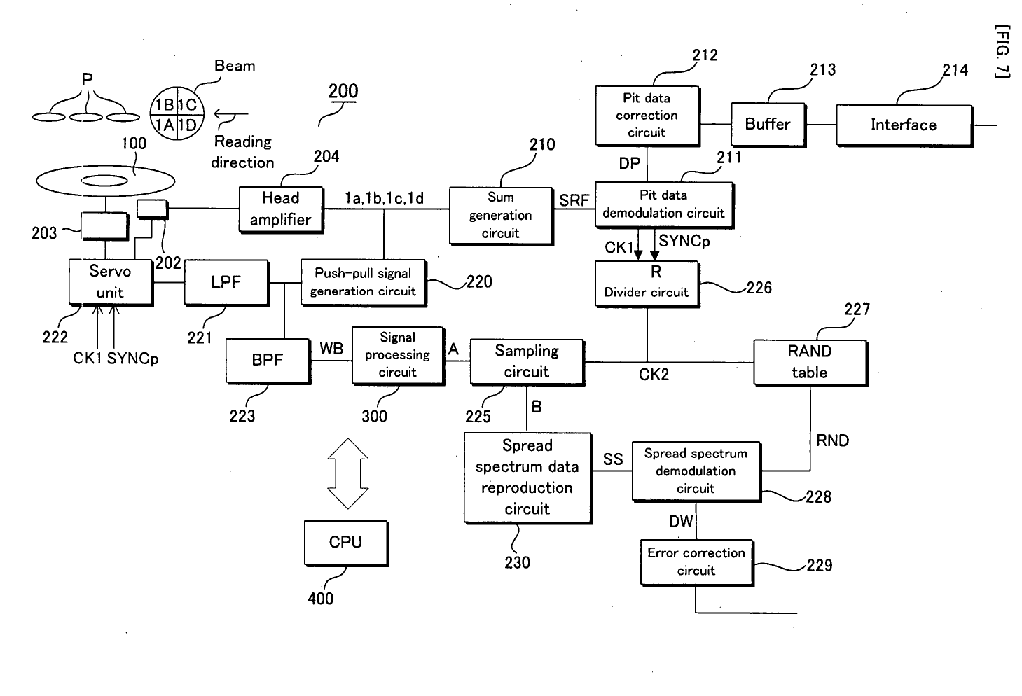

Next, an information recording/reproducing apparatus in an embodiment of the information reproducing apparatus of the present invention will be explained. FIG. 7 is a block diagram showing the entire structure of the information recording/reproducing apparatus in the embodiment of the information reproducing apparatus of the present invention. On the optical disc 100, pit data DP synchronized with a first clock signal CK1 is recorded in accordance with the length of a record mark. The record mark in this example is a pit, and the track is constructed from a pit row. The track has a meandering shape in accordance with a wobble signal WB obtained by the spread spectrum modulation of wobble data DW. The wobble signal WB is synchronized with a second clock signal CK2. The first clock signal CK1 has a frequency which is N times (N is a natural number) as much as that of the second clock signal CK2. In this example, N=25, the second clock signal CK2 is 420 KHz, and the first clock signal CK1 is 10.5 MHz.

An information recording/reproducing apparatus 200 is provided with: an optical pickup 202 for irradiating a reproduction beam onto the optical disc 100 and outputting a signal responding to reflected light; a spindle motor 203 for controlling the rotation of the optical disc 100; and a servo unit 222. The servo unit 222 is synchronized with these signals, and performs spindle servo for controlling the rotation of the spindle motor 203, and focus servo and tracking servo for performing relative position control of the optical pickup 202 to the optical disc 100.

The optical pickup 202 is provided with a laser diode for irradiating the reproduction beam; and a not-illustrated four-division detection circuit. The four-division detection circuit divides the reflected light of the reproduction beam into four areas 1A, 1B, 1C, and 1D shown in FIG. 7, and outputs each signal corresponding to the quantity of light in respective one of the areas. A head amplifier 204 amplifies each output signal of the optical pickup 202, and outputs a divisional read signal 1a corresponding to the area 1A, a divisional read signal 1b corresponding to the area 1B, a divisional read signal 1c corresponding to the area 1C, and a divisional read signal 1d corresponding to the area 1D. Incidentally, the optical pickup 202 and the head amplifier 204 correspond to the optical pickup device of the present invention.

A sum generation circuit 210 is provided with an adder circuit for adding the divisional read signals 1a, 1b, 1c, and 1d and for outputting a sum read signal SRF. Incidentally, the sum read signal SRF is a signal which represents the length of the record mark.

A pit data demodulation circuit 211 reproduces the pit data DP on the basis of the sum read signal SRF, and generates the first clock signal CK1. More specifically, the reproduced pit data DP is demodulated by using a predetermined table, to thereby generate reproduction data. For example, if EFM modulation is adopted as a modulating method, a process of converting 14-bit pit data DP to 8-bit reproduction data is performed. Then, a descramble process is performed in which the order of the reproduction data is rearranged in accordance with a predetermined rule, and the processed reproduction data is outputted.

The reproduction data obtained in this manner is supplied to a pit data correction circuit 212 shown in FIG. 7, on which an error correction process and an interpolation process are performed, and then, it is stored into a buffer 213. An interface 214 sequentially reads the data stored in the buffer 213, converts it in a predetermined output format, and outputs it to external equipment.

A push-pull signal generation circuit 220 calculates (1a+1d)−(1b+1c) and generates a push-pull signal. The component (1a+1d) corresponds to the areas 1A and 1D which are on the left side with respect to the reading direction, while the component (1b+1c) corresponds to the areas 1B and 1C which are on the right side with respect to the reading direction. Namely, if the reproduction beam is disproportionately on the left with respect to the pit, the push-pull signal is positive on the basis of the center of amplitude. If the reproduction beam is located in the center of the pit, the value of the push-pull signal is in the center of amplitude. If the reproduction beam is disproportionately on the right with respect to the pit, the push-pull signal is negative on the basis of the center of amplitude. The relative position of the reproduction beam and the pit changes depending on the meandering of the track, and the value of the push-pull signal indicates a relative position relationship between the reproduction beam and the pit.

The push-pull signal is outputted to the servo unit 222 through a low pass filter 221. The servo unit 222 performs the tracking control on the basis of the push-pull signal. Moreover, the push-pull signal is supplied to a band pass filter 223. The passband of the band pass filter 223 is set to extract the wobble signal SB obtained by the spread spectrum modulation of the wobble data DW from the push-pull signal at the time of recording. Therefore, the band pass filter 223 constitutes the above-mentioned address detecting device, together with the push-pull signal generation circuit 220, and its output signal is obtained by reproducing the wobble signal WB from the optical disc 100. The wobble signal WB is supplied to a signal processing circuit 300. In particular, the signal processing circuit 300 will be explained in detail next.

(Detailed Explanation of Signal Processing Circuit of Information Recording/Reproducing Apparatus)

Next, with reference to FIG. 8 and FIG. 9, a detailed explanation will be given for the structure of the signal processing circuit of the information recording/reproducing apparatus in the embodiment of the information reproducing apparatus of the present invention, and the detection operation of the layer judgment information, i.e. an operation of judging the recording layer. FIG. 8 is a block diagram showing the structure of the signal processing circuit in the embodiment of the information reproducing apparatus of the present invention. FIG. 9 are timing charts showing the operation of judging the recording layer by using the signal processing circuit in the embodiment of the information reproducing apparatus of the present invention.

As shown in FIG. 8, the signal processing circuit 300 is provided with: an analog comparator 301; a counter circuit 302; a latch circuit 303; and a digital comparator 304.

Firstly, the push-pull signal shown in FIG. 9(a) is supplied to the analog comparator 301. The analog comparator 301 outputs the supplied push-pull signal, as a FM (Frequency Modulation) pulse signal shown in FIG. 9(b). Specifically, the FM pulse signal is binarized, and converted to make the level of the FM modulation signal as “High” if it is larger than a slice level. In addition to this, the FM pulse signal is converted to make the level of the FM modulation signal as “Low” if it is smaller than a slice level. More specifically, the analog comparator 301 is provided with an auto slicer 301a. The auto slicer 301a determines the slice level and detects the leading edge and the trailing edge of the converted FM pulse signal. Hereinafter, the detected leading and trailing edges are referred to as a “both-edge signal”. The both-edge signal is supplied to the counter circuit 302, the latch circuit 303, and the digital comparator 304.

A clock signal CK and a reset signal RST based on the both-edge signal are supplied to the counter circuit 302. The counter circuit 302 counts (integrates) the clock signal CK and outputs a count value to the latch circuit 303, as shown in FIG. 9(c). Specifically, the counter circuit 302 is reset by using the reset signal RST, and counts (integrates) between the leading edge and the trailing edge.

As shown in FIGS. 9(c) and 9(d), when the count value is counted up to “N” (which is corresponding to “1” cycle), the reset by using the reset signal RST is performed, and the count value becomes “0”. Alternatively, after the reset, the count of the count value is restarted, and when the count value is counted up to “N/2”, the reset by using the reset signal RST is performed. As described above, the count value when the reset signal RST is performed is, for example, “N”, “N”, “N”, “N”, “N”, “N/2”, “N/2”, “N”, and “N”.

The count value from the counter circuit 302 and the both-edge signal are supplied to the latch circuit 303. The latch circuit 303 maintains the count value, on the basis of the timing of the both-edge signal. As shown in FIG. 9(d), the latch circuit 303 maintains the above-mentioned count value when the reset by using the reset signal RST is performed. The maintained count value is outputted to the digital comparator 904.

The count value from the latch circuit 303 and a count threshold value “¾N” are supplied to the digital comparator 304. The digital comparator 304 (i) performs a comparison process, on the basis of the count value supplied from the latch circuit 303 and the supplied count threshold value, (ii) removes the high frequency component “N/2” of the FM modulation signal, and (iii) outputs “0”. As described above, the FM modulation signal on which the comparison process is performed, is outputted to the CPU 400.

The CPU 400 detects the output value of the FM modulation signal after predetermined number of the count, from the synchronization signal Sync, such as the above-mentioned land pre-pit LP. Specifically, the CPU 400 measures the output values of the FM modulation signals of the fifth, sixth, seventh and eighth wobbles, on the basis of the table about the layer judgment information 113 shown in FIG. 6 described above, to thereby judge in what number of the wobble from the synchronization (sync), the output value of the digital comparator 304 is not outputted, that is, by detecting “0”, the CPU 400 can judge what recording layer in which the tracking is performed. Incidentally, if “0” is not detected, it can judge that the recording layer is L0 layer. Specifically, as shown in FIG. 9(e), “0” is detected as the output value of the FM modulation signal in the fifth wobble, so that it is possible to judge that the recording layer is L1 layer that the tracking is being performed.

(Explanation of Entire Information Recording/Reproducing Apparatus—Continued from the Previous Explanation—)

Next, back in FIG. 7 again, the explanation of the entire information recording/reproducing apparatus will be continued.

A spread spectrum data reproduction circuit 230 reproduces spread spectrum data SS, on the basis of data B. The details of the spread spectrum data reproduction circuit 230 vary depending on which modulation method is used in preparing a disc master DS.

A randomization pattern used for the spread spectrum modulation at the time of recording is stored on a RAND table 220. The randomization pattern corresponds to a spread code, and it is a bit row generated by using a random function. The second clock signal CK2 is supplied to the RAND table 227, and the randomization pattern is read in synchronization with the second clock signal CK2. By this, random data RND is generated, and the generated random data RND is supplied to a spread spectrum demodulation circuit 228. Moreover, the spread spectrum data SS outputted from the spread spectrum data reproduction circuit 230 is supplied to the spread spectrum demodulation circuit 228.

The spread spectrum demodulation circuit 228 is provided with a multiplier circuit (e.g. exclusive OR circuit XOR), and reproduces the wobble data DW by multiplying the spread spectrum data SS and the random data RND. At this time, the signal which is not in the original signal band, is converted to an out-of-band signal by the multiplication. The wobble data DW reproduced in this manner is error-corrected on an error correction circuit 229 and then outputted.

### Second Embodiment of Information Recording Medium

Next, with reference to FIG. 10, an optical disc in a second embodiment of the information recording medium of the present invention will be explained in more detail. FIG. 10 is a conceptual view schematically showing the wobble formed in the L0 layer to the L3 layer of the optical disc in the second embodiment of the information recording medium of the present invention, and the sync frame as the physical format of the optical disc.

The basic structure and the physical format of the optical disc in the second embodiment are substantially the same as those in the first embodiment explained with reference to FIG. 1 to FIG. 4.

As shown in FIG. 10, particularly, in the L1 layer of the optical disc in the second embodiment, at the top of the fourth wobble 109 out of the eight wobbles 109 in one sync frame, there is formed a land pre-pit LP1 which is the same (or in the same side) in the disc radial direction as the land-pre-pits LP formed in the front area 111. Incidentally, one example of the “first land pre-pit” of the present invention is constructed from the land pre-pit LP1 formed in the second area. From the opposite viewpoint, by that the detection circuit of the information reproducing apparatus described above detects the land pre-pit LP1 as the top of the fourth wobble 109, it is possible to judge that the recording layer in which the tracking is being performed is the L1 layer.

In the same manner, in the L2 layer of the optical disc in the second embodiment, the land pre-pit LP1 is formed at the top of the fifth wobble 109 out of the eight wobbles 109 in one sync frame. From the opposite viewpoint, by that the detection circuit of the information reproducing apparatus detects that the land pre-pit LP1 is formed at the top of the fifth wobble 109, it is possible to judge that the recording layer in which the tracking is being performed is the L2 layer. Moreover, in the L3 layer of the optical disc in the second embodiment, the land pre-pit LP1 is formed at the top of the sixth wobble 109 out of the eight wobbles 109 in one sync frame. From the opposite viewpoint, by that the detection circuit of the information reproducing apparatus detects that the land pre-pit LP1 is formed at the top of the sixth wobble 109, it is possible to judge that the recording layer in which the tracking is being performed is the L3 layer.

### Third Embodiment of Information Recording Medium

Next, with reference to FIG. 11, an optical disc in a third embodiment of the information recording medium of the present invention will be explained in more detail. FIG. 11 is a conceptual view schematically showing the wobble formed in the L0 layer to the L3 layer of the optical disc in the third embodiment of the information recording medium of the present invention, and the sync frame as the physical format of the optical disc.

The basic structure and the physical format of the optical disc in the third embodiment are substantially the same as those in the first embodiment explained with reference to FIG. 1 to FIG. 4.

As shown in FIG. 11, in the L1 layer of the optical disc in the third embodiment, at the lower top (or bottom) of fourth wobble 109 out of the eight wobbles 109 in one sync frame, there is formed a land pre-pit LP2 which is opposite side in the disc radial direction, to the land pre-pits LP formed in the front area 111. Incidentally, one example of the “second land pre-pit” of the present invention is constructed from the land pre-pit LP2 formed in the second area. From the opposite viewpoint, by that the detection circuit of the information reproducing apparatus described above detects the land pre-pit LP2 at the lower top of the fourth wobble 109, it is possible to judge that the recording layer in which the tracking is being performed is the L1 layer.

In the same manner, in the L2 layer of the optical disc in the third embodiment, the land pre-pit LP2 is formed at the lower top (or bottom) of the fifth wobble 109 out of the eight wobbles 109 in one sync frame. From the opposite viewpoint, by that the detection circuit of the information reproducing apparatus detects that the land pre-pit LP2 is formed at the lower top (or bottom) of the fifth wobble 109, it is possible to judge that the recording layer in which the tracking is being performed is the L2 layer. Moreover, in the L3 layer of the optical disc in the third embodiment, the land pre-pit LP2 is formed at the lower top (or bottom) of the sixth wobble 109 out of the eight wobbles 109 in one sync frame. From the opposite viewpoint, by that the detection circuit of the information reproducing apparatus detects that the land pre-pit LP2 is formed at the lower top (or bottom) of the sixth wobble 109, it is possible to judge that the recording layer in which the tracking is being performed is the L3 layer.

### Fourth Embodiment of Information Recording Medium

Next, with reference to FIG. 12, an optical disc in a fourth embodiment of the information recording medium of the present invention will be explained in more detail. FIG. 12 is a conceptual view schematically showing the wobble formed in the L0 layer to the L3 layer of the optical disc in the fourth embodiment of the information recording medium of the present invention, and the sync frame as the physical format of the optical disc.

The basic structure and the physical format of the optical disc in the fourth embodiment are substantially the same as those in the first embodiment explained with reference to FIG. 1 to FIG. 4.

As shown in FIG. 12, particularly, in the L1 layer of the optical disc in the fourth embodiment, a signal from another information is superimposed to the top of the fourth wobble 109b out of the eight wobbles 109 in one sync frame. Incidentally, one example of the “second wobble” of the present invention is constructed from the wobble 109b to which the signal from another information is superimposed and which is formed in the second area. From the opposite viewpoint, by that the detection circuit of the information reproducing apparatus described above detects the wobble 109b as the fourth wobble, it is possible to judge that the recording layer in which the tracking is being performed is the L1 layer.

In the same manner, in the L2 layer of the optical disc in the fourth embodiment, the signal from another information is superimposed to the top of the fifth wobble 109b out of the eight wobbles 109 in one sync frame. From the opposite viewpoint, by that the detection circuit of the information reproducing apparatus detects the wobble 109b as the fifth wobble, it is possible to judge that the recording layer in which the tracking is being performed is the L2 layer. Moreover, in the L3 layer of the optical disc in the fourth embodiment, the signal from another information is superimposed to the top of the sixth wobble 109b out of the eight wobbles 109 in one sync frame. From the opposite viewpoint, by that the detection circuit of the information reproducing apparatus detects the wobble 109b as the sixth wobble, it is possible to judge that the recording layer in which the tracking is being performed is the L3 layer.

Incidentally, in the above-mentioned first to fourth embodiments, the layer judgment information is recorded only in the second area; however, in addition to the second area, the layer judgment information may be recorded in the land pre-pit LP in the first area, as in a conventional manner. Namely, the layer judgment information may be detected by two types of detection circuits. As described above, by verifying or checking the layer judgment information detected by the two types of detection circuits, it is possible to further improve the accuracy of the detected layer judgment information. Moreover, it is also possible to maintain compatibility with the detection circuit of a conventional information reproducing apparatus.

In the embodiments, as one specific example of the information recording medium, a rewritable type optical disc, such as a CD-R/W or a DVD-R/W, for example, is explained. The present invention, however, can be also applied to an optical information recording medium, such as all types of CDs and DVDs which use the wobble, and a large-volume recording medium like a Blu-ray disc, for example.

The present invention is not limited to the above-described embodiments, and various changes may be made, if desired, without departing from the essence or spirit of the invention which can be read from the claims and the entire specification. An information recording medium, an information reproducing apparatus, and an information reproducing method, which involve such changes, are also intended to be within the technical scope of the present invention.

### INDUSTRIAL APPLICABILITY

The information recording medium, the information reproducing apparatus, and the information reproducing method of the present invention can be applied to a high-density optical disc, such as a DVD, and also applied to a DVD player or the like.

1-10. (canceled)

11. An information recording medium, comprising:
a plurality of recording layers, on each of which a groove track, which is wobbled at a first frequency and in which record information can be recorded, is formed in advance,
the groove track comprising: a first area in which synchronization information and address information can be detected; and a second area which is wobbled at a second frequency different from the first frequency,
each of the plurality of recording layers capable of being judged by a combination of the second area and the first area along a track direction of the groove track.

12. The information recording medium according to claim 11, wherein the groove track includes a first wobble which is wobbled at the second frequency, in the second area.

13. The information recording medium according to claim 11, wherein the groove track includes a first land pre-pit which is formed at the same side in a radial direction of said information recording medium, as a land pre-pit formed in the first area.

14. The information recording medium according to claim 11, wherein the groove track includes a second land pre-pit which is formed at opposite side in a radial direction of said information recording medium, to a land pre-pit formed in the first area.

15. The information recording medium according to claim 11, wherein the groove track includes a second wobble to which a signal of another information is superimposed.

16. The information recording medium according to claim 11, wherein the groove track includes a third wobble having a phase different from that of another wobble.

17. The information recording medium according to claim 11, wherein the groove track includes a fourth wobble having an amplitude different from that of another wobble.

18. The information recording medium according to claim 11, wherein layer judgment information is recorded, not only in the second area but also in the first area, in addition to the synchronization information and the address information.

19. An information reproducing apparatus for reproducing the record information on said information recording medium, said information recording medium, comprising:
a plurality of recording layers, on each of which a groove track, which is wobbled at a first frequency and in which the record information can be recorded, is formed in advance,
the groove track comprising: a first area in which synchronization information and address information can be detected; and a second area which is wobbled at a second frequency different from the first frequency,
each of the plurality of recording layers capable of being judged by a combination of the second area and the first area along a track direction of the groove track;
said information reproducing apparatus comprising:
an optical pickup device for irradiating laser light onto the groove track and receiving its reflected light;
an address detecting device for detecting the synchronization information and the address information recorded on said information recording medium, on the basis of an output of said optical pickup device; and
a recording-layer detecting device for detecting layer judgment information recorded on said information recording medium, on the basis of the output of said optical pickup device.

20. An information reproducing method of reproducing the record information on said information recording medium, said information recording medium, comprising:
a plurality of recording layers, on each of which a groove track, which is wobbled at a first frequency and in which the record information can be recorded, is formed in advance,
the groove track comprising: a first area in which synchronization information and address information can be detected; and a second area which is wobbled at a second frequency different from the first frequency,
each of the plurality of recording layers capable of being judged by a combination of the second area and the first area along a track direction of the groove track;
said information reproducing method comprising:
a reading process of irradiating laser light onto the groove track and receiving its reflected light;
an address detecting process of detecting the synchronization information and the address information recorded on said information recording medium, on the basis of an output of said reading process; and
a recording-layer detecting process of detecting layer judgment information recorded on said information recording medium, on the basis of the output of said reading process.

21. The information recording medium according to claim 11, wherein the combination is a combination in a position relationship between the first area and the second area.
